(19) United States
(12) Patent Application Publication
(10) Pub. No.: US 2005/0208338 A1
(43) Pub. Date: Sep. 22, 2005

(54) Heat resistant product

(76) Inventors: John Andrew Fernie, Cambridge (GB); Alan Taylor, Cambridge (GB); Paul Jackson, Cambridge (GB)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/517,061

(22) PCT Filed: Jun. 3, 2003
(86) PCT No.: PCT/GB03/02409

§ 371 Date: May 26, 2005

(30) Foreign Application Priority Data
Jun. 10, 2002 (GB) GB02/02647
Nov. 19, 2002 (GB) 0226997.5

(51) Int. Cl. C04B 35/04; B32B 9/00

(52) U.S. Cl. 428/701; 501/120

(57) ABSTRACT

A composition comprising a matrix which, on pyrolysis, forms spinel, and an inorganic particulate filler having a hollow or a lamellar structure, wherein the matrix comprises a liquid pre-ceramic binder and at least one other component selected from a metal powder, a metal oxide powder and mixtures thereof, is provided. A heat resistant product which is obtainable by pyrolysing the composition is also provided. The resulting heat resistant product is capable of withstanding temperatures of greater than 1600° C., for instance up to and greater than 1850° C., and may be used in the form of a thermal barrier coating applied, or otherwise attached, to a surface of a substrate, which may, for example, form part of an aircraft, power-generating equipment, a furnace lining, a heat-exchanger, or a reactor.

### FIELD OF THE INVENTION

The invention relates to novel compositions which are useful as thermal barrier coatings (TBCs), and heat resistant products generally, capable of withstanding temperatures of greater than 1600° C., for instance up to and greater than 1850° C.

### BACKGROUND TO THE INVENTION

There are many applications where heat insulation and fire resistance to extreme temperatures is required. Important examples include heat shields for high performance aircraft; power-generating equipment, such as gas turbines, combustion engines and other engine parts; furnace linings; and heat-exchangers. With the increasing temperature demands in these fields comes a need for better heat insulation and fire resistance.

U.S. Pat. No. 6,013,592 describes a ceramic composition for the insulation of ceramic matrix composites exposed to temperatures of up to approximately 1600° C., and which comprises a plurality of hollow oxide-based spheres, a phosphate binder and at least one oxide filler powder, wherein the phosphate binder partially fills gaps between the hollow spheres and the filler powder.

WO-A-0146084 describes a high temperature, erosion resistant coating material comprising a close-packed array of hollow geometric shapes, preferably hollow ceramic spheres, and having a matrix binder material between the geometric shapes which is derived from a liquid ceramic binder. Examples of suitable ceramic binders are aluminium orthophosphate solution; alumina, mullite or silica sols; and aluminium hydroxyl chloride. The liquid ceramic binder is used to coat the geometric shapes, and on firing bonds those shapes together at their points of contact.

The art is continually seeking new heat resistant coatings and products, especially for the very high temperature applications mentioned above.

### SUMMARY OF THE INVENTION

According to a first aspect of the present invention, a composition comprises a matrix which, on pyrolysis, forms spinel, and an inorganic particulate filler having a hollow or a lamellar structure, wherein the matrix comprises a liquid pre-ceramic binder and at least one other component selected from a metal powder, a metal oxide powder and mixtures thereof.

According to a second aspect of the present invention a product is obtainable by pyrolysing a composition as defined above. The resulting heat resistant product is capable of withstanding temperatures of greater than 1600° C., for instance up to and greater than 1850° C., and may be used in the form of a thermal barrier coating applied, or otherwise attached, to a surface of a substrate, which may, for example, form part of an aircraft, power-generating equipment, a furnace lining, a heat-exchanger, or a reactor.

According to a third aspect of the present invention, a method of manufacturing a heat resistant product comprises mixing together a matrix which, on pyrolysis, forms spinel, and an inorganic filler having a hollow or a lamellar structure; and pyrolysing the resultant mixture.

Additional aspects of the present invention are evident from the claims appended hereto.

### DESCRIPTION OF THE INVENTION

The novel composition of the present invention, on heating or pyrolysis, forms the magnesium aluminium oxide spinel, or a derivative thereof.

In the context of the present Application, the term “pre-ceramic” is intended to embrace any material which, on pyrolysis, forms a ceramic material. The pre-ceramic binder for use in the present invention may be any binder which, on pyrolysis, decomposes and interacts with the metal powder and/or metal oxide powder mixed therewith to form spinel. The pre-ceramic binder is liquid in nature, and is typically a liquid mixture of active binder material and a liquid medium. The binder may vary considerably in viscosity, for example taking the form of a paste, slurry or solution, depending on the concentration of active binder material and any medium in which this is dispersed or dissolved. By “active binder material” it is meant that material which, on pyrolysis, actually interacts with the metal powder and/or metal oxide powder.

Examples of pre-ceramic binders which may find use in the present invention include aluminium nitrate nonahydrate, aluminium chlorohydrate, magnesium nitrate nonahydrate, magnesium chloride hexahydrate and mixtures thereof. Although other aluminium and/or magnesium-containing pre-ceramic binders may be envisaged.

Typically, the aluminium- and magnesium-containing binders are used in the form of aqueous mixtures, for example slurries or solutions. In this case, the amount of active binder material and water must be controlled to achieve adequate reaction and yet minimise shrinkage on evaporation, as the latter may cause cracking of the resulting heat resistant product or coating. Therefore, the concentration of active binder material used will depend on the nature of the other components in the composition, and may also depend on the nature of the substrate on to which the composition is to be coated or otherwise attached. Typically, the concentration of active binder material in water will lie in the range 10 to 95 wt. %, for instance 30 to 90 wt. %, or 40 to 75 wt. %. Generally, however, it is preferred to use a solution which is close to, or at, saturation with the active binder material.

The metal powder or metal oxide powder may be any metal or metal oxide which will produce spinel on pyrolysis with the pre-ceramic binder. In the context of the present Application, such metal or metal oxide powders are referred to as “reactive” powders, and the term “metal” is intended to include silicon. Examples of suitable metals include aluminium, magnesium and mixtures thereof. Examples of suitable metal oxides include alumina, magnesia, talc (3MgO.4SiO₂.H₂O), and mixtures thereof.

In the context of the present Application the term “powder” includes any particulate material having sufficient surface area to react with the pre-ceramic binder. Typically, the powder has a particle of size up to about 30 μm, preferably up to about 20 μm and more preferably up to about 10 μm.

In certain cases, it may be necessary, or desirable, to use a mixture of metal powders and/or metal oxide powders. For instance, while the pre-ceramic binder typically provides at least one of the species to be incorporated into the spinel matrix, this species may not be present in sufficient amount in the binder per se. Therefore, it may need to be supplemented by the use of an appropriate metal and/or metal oxide powder.

Examples of particularly preferred matrix compositions of the present invention include combinations of an aluminium chlorohydrate binder and talc, and optionally alumina; an aluminium nitrate nonahydrate binder and magnesia or talc, and optionally alumina; and a binder comprising magnesium chlorohexahydrate or magnesium nitrate nonahydrate with alumina, and optionally a source of reactive magnesium, such as magnesia or talc.

The choice of combination of pre-ceramic binder and metal and/or metal oxide may be influenced by the ease of control of the kinetics of reaction between the materials. For example, if the precursor composition comprises aluminium chlorohydrate as the binder, it is generally not desirable to combine this with magnesia, as the reaction between the two materials is difficult to control. In such a case, talc is preferentially used in place of magnesia.

The precise proportions of pre-ceramic binder and metal and/or metal oxide powder will depend upon the particular combination of materials selected. Generally, however, the amount of liquid pre-ceramic binder should be sufficient to form a homogeneous paste or slurry on mixing with the other components of the matrix. Typically, the amount of pre-ceramic binder material included in the precursor composition will comprise 5 to 50 wt. %, and more preferably 15 to 40 wt. %, of the total weight of the unpyrolysed, or wet, composition. Generally, the reactive metal and/or metal oxide powder will be used in a stoichiometric amount with the binder, or in an excess thereof, to obtain the desired mixed metal oxide. In this sense, in determining the amount of metal and/or metal oxide powder to be used, the amount of any reactive species present in the binder per se should be taken into account, particularly where such reactive species have been supplemented through the use of additional metal and/or metal oxide powders. Typically, however, the amount of reactive metal and/or metal oxide powder will be in the range 5 to 40 wt. %, preferably 10 to 30 wt. %, of the total weight of the unpyrolysed, or wet, composition.

The inorganic particulate hollow or lamellar filler may be any material which has the ability to trap air within the pyrolysed composition. Therefore, potentially fillers having structures other than a hollow or lamellar structure may be of use in the present invention. Furthermore, mixtures of different hollow and/or lamellar fillers may also be used.

The inorganic hollow or lamellar filler may undergo some reaction during pyrolysis of the matrix, for instance at the surface of the filler, which may give rise to an increase in strength of the final product. Typically, however, any such reaction will not be extensive.

If a hollow filler is used, this will typically be in the form of hollow spheres, but other hollow shapes may also be envisaged. Hollow oxide-based fillers are preferred, and include alumina, yttria-stabilised zirconia, spinel, mullite and other ceramic fillers. Commercially-available oxide-based ceramic fillers suitable for use in the present invention include the oxide-based ceramic fillers disclosed in U.S. Pat. No. 6,013,592, for example, mullite hollow spheres (available from Keith Ceramics, UK); aluminosilicate E-spheres (available as SLG and E-150 from 3M Specialty Materials); and bubble alumina (available from PEM ABRASIFS and Washington Mills). The particle size of the hollow filler can vary quite considerably, but is typically at least 50 μm, preferably 150 μm to 5 mm, more preferably 300 μm to 3 mm. Mixtures of different hollow fillers and/or different sizes of hollow fillers may also be used, and may be desirable to optimise the physical properties of the final heat resistant product.

Suitable inorganic lamellar materials for use in the present invention include any material having a platelet character, for instance micaceous materials, clays and perlite. Preferably, the inorganic lamellar material is an hydrated mica, and more preferably it is vermiculite or montmorillonite, as these materials have distinct cost advantages over other lamellar materials. Typically, the particle size of the lamellar material will be at least 0.5 mm, preferably greater than 0.5 mm, and more preferably at least 1 mm. Below 0.5 mm the lamellar character of the filler may be lost.

The amount of inorganic particulate hollow or lamellar filler may vary considerably according to the intended application of the heat resistant product. Typically, however, the composition comprises 10 to 95 wt. %, preferably 30 to 60 wt. %, and more preferably 20 to 50 wt. %, of such inorganic filler, based upon the total weight of the unpyrolysed, or wet, composition. Depending on the relative amounts of matrix and filler, the filler particles may be dispersed in the matrix or the matrix may simply act to bond the filler particles together.

The remainder of the composition may comprise matrix alone. Alternatively, the composition may comprise additional inorganic filler, capable of adding functionality or adjusting the properties of the spinel product formed on pyrolysis. This additional filler may be particulate or fibrous in nature. Suitable materials include those which vary the thermal conductivity and thermal expansion properties of the product, its density, its strength, and/or its erosion resistance. Examples include alumina, magnesia, silica, zirconia, ceria, hafnia, aluminium silicates, such as mullite, vermiculite flour (ie. crushed, non-lamellar vermiculite), spinel powder, silicon carbide, silicon nitride, aluminium nitride, and mixtures thereof. Typically, the filler particle size is in the range 30 μm to less than 1000 μm, and is typically larger than any reactive metal and/or metal oxide powder included in the composition.

Typically, this additional filler may be included in an amount of up to 75 wt. %, preferably 10 to 50 wt. %, more preferably 15 to 40 wt. %, based on the total weight of the unpyrolysed, or wet, composition. A preferred composition comprises 30 to 60 wt. % hollow or lamellar filler, 15 to 40 wt. % additional filler, with the balance being matrix.

In order to make a heat resistant product or thermal barrier coating according to the present invention, the matrix components are mixed together with the hollow or lamellar filler and any other optional ingredients desired to be incorporated in the final product or coating, and the resultant mixture is then pyrolysed, or heated, to cause formation of spinel. Preferably, the pyrolysis conditions are chosen to achieve complete conversion to spinel. Although, products containing mixed metal oxide intermediates en route to spinel and products containing multiple phases of which only one is spinel, are also covered by the present invention.

Pyrolysis is usually conducted in air, for instance in an oven or furnace. Although, other conventional heating techniques may be used, for instance microwave, radio frequency induction, or power beam radiation. Typically, heating to a temperature of at least 1000° C. will be required, although at the lower end of this temperature range extended periods of heating may be required to obtain the desired spinel product. Accordingly, it is preferred to use temperatures in excess of this, for instance of at least 1200° C., more preferably of at least 1300° C., and most preferably of at least 1400° C. Generally the higher the temperature the better the mechanical properties of the resulting product.

Prior to pyrolysis, the composition may be moulded into a desirable shape. The resulting heat resistant product may subsequently be attached to the surface of an article using a suitable adhesive, or by mechanical or any other suitable means. Alternatively, the composition may be applied to the surface of an article prior to pyrolysis and then pyrolsed in situ, provided that the temperature used for pyrolysis does not damage the article. For instance, the composition may be coated or sprayed on to the surface of an article, or it may be moulded and air-dried or dried at moderate elevated temperature e.g. about 60° C., to produce a “green” (i.e. uncured) structure which has good strength and which is self-standing under its own weight, and which may then be attached to the surface of an article.

The resulting heat resistant product may comprise hollow or lamellar inorganic filler particles dispersed in a matrix of spinel, or hollow or lamellar particles bonded together by spinel, according to the relative proportions of the materials used.

The resulting heat resistant product or thermal barrier coating can be used to protect a wide variety of different materials, including metals, ceramics and composites. However, the product has particular utility in the protection of ceramic matrix composites, more particularly oxide-oxide ceramics, such as those sought to be used in the aerospace industry and in the power-generating industry, and in the protection of high temperature metallics, eg. nickel alloys and titanium alloys. The heat resistant product also finds use in many other applications, including in furnace linings and as components of heat exchangers, and as linings and components of a wide variety of reactors.

The present invention is now further illustrated by the following examples.

### EXAMPLES

### Example 1

A heat resistant product suitable for use as thermal barrier coating was prepared by mixing together the following components:

| | |
|---|---|
| 14.0 g | coarse alumina filler powder (>50 μm) |
| 6.0 g | fine alumina powder (approx. 1.8 μm) |
| 1.0 g | fine talc powder (approx. 6 μm) |
| 7.5 g | bubble alumina, from PEM ABRASIFS (approx. |
| | 0.5-1 mm) |
| 6.0 g | 25 wt. % aluminium chlorohydrate solution in |
| | water, from Rhodia Specialty Phosphates. |

The resulting mixture was transferred to a mould, and dried using the following temperature profile:
1) room temperature increased to 60° C. at a rate of 1° C./min, and held for 10 hours at 60° C.;
2) 60° C. increased to 120° C. at a rate of 1° C./min, and held at 120° C. for 10 hours; and
3) cooled from 120° C. to room temperature at a rate of 1° C./min.

The sample was then extracted from the mould and fired using the following temperature profile:
1) room temperature increased to 1200° C. at a rate of 5° C./min, and held for 15 minutes;
2) 1200° C. increased to 1600° C. at a rate of 3° C./min, and held for 2 hours; and
3) cooled from 1600° C. to room temperature at a rate of 2° C./min.

The resulting 5 mm thick product sample was placed at the entrance of a furnace, and thermocouples were positioned at the hot-face (ie. that facing the furnace) and cold-face of the sample. The furnace temperature was raised until the hot-face temperature measured 1600° C., and the cold-face temperature was then recorded over a period of 100 minutes. There was no forced cooling of the cold-face, it was simply open to air.

The steady-state temperature at the cold-face of the sample was recorded to be approximately 970° C. over the entirety of the measurement period, demonstrating the enhanced thermal resistance of the product of the present invention.

### Example 2

Example 1 was repeated, using a mixture of the following components:

| | |
|---|---|
| 7.0 g | coarse alumina filler powder (>50 μm) |
| 3.0 g | fine alumina powder (approx. 1.8 μm) |
| 1.0 g | fine magnesia powder (<10 μm) |
| 20.0 g | bubble alumina, from PEM ABRASIFS (approx |
| | 0.5-1 mm) |
| 9.0 g | 66 wt. % magnesium chloride hexahydrate |
| | solution in water. |

The thermal resistance of the resulting 5 mm product was tested in the same manner as described in Example 1. The steady-state temperature at the cold-face of the sample was recorded to be approximately 910° C. over the entirety of the measurement period. This improvement in thermal resistance compared to Example 1 is due to the use of a higher amount of bubble alumina.

1. A composition comprising a matrix which, on pyrolysis, forms spinel, and 20 to 95 weight % of an inorganic particulate filler having a hollow or a lamellar structure, wherein the matrix comprises a liquid pre-ceramic binder and at least one other component selected from a metal powder, a metal oxide powder and mixtures thereof.

2. A composition according to claim 1, wherein the liquid pre-ceramic binder comprises a material selected from aluminium-containing pre-ceramic materials and magnesium-containing pre-ceramic materials.

3. A composition according to claim 2, wherein the liquid pre-ceramic binder comprises a material selected from aluminium chlorohydrate, aluminium nitrate nonahydrate, magnesium chloride hexahydrate, magnesium nitrate nonahydrate and mixtures thereof.

4. A composition according to claim 3, wherein the matrix comprises an aluminium chlorohydrate binder and talc.

5. A composition according to claim 3, wherein the matrix comprises an aluminium nitrate nonahydrate binder and a metal oxide selected from the group consisting of magnesia, talc and mixtures thereof.

6. A composition according to claim 5, wherein the matrix additionally comprises alumina.

7. A composition according to claim 3, wherein the matrix comprises a pre-ceramic binder selected from the group consisting of magnesium chloride hexahydrate and magnesium nitrate nonahydrate; a metal oxide selected from the group consisting of magnesia, talc and mixtures thereof; and alumina.

8. A composition according to claim 1, wherein the filler comprises hollow particles of an inorganic oxide.

9. A composition according to claim 1, wherein the filler comprises a micaceous material.

10. A composition according to claim 9, wherein the filler comprises vermiculite.

11. A composition according to claim 1, which comprises 10 to 95 weight %, preferably 20 to 70 wt. %, hollow or lamellar filler.

12. A composition according to claim 1, which comprises an inorganic filler in addition to the filler having a hollow or a lamellar structure.

13. A product obtainable by pyrolysing a composition as defined in claim 1.

14. An article comprising a substrate and, attached to or coated on a surface of the substrate, a product as defined in claim 13.

15. An article according to claim 14, wherein the substrate is a ceramic material.

16. An article according to claim 14, wherein the substrate forms part of an article selected from the group consisting of an aircraft, power-generating equipment, a furnace lining, a heat-exchanger, and a reactor.

17. A method of manufacturing a heat resistant product, the method comprising mixing together a matrix which, on pyrolysis, forms spinel and comprises a liquid pre-ceramic binder and at least one other component selected from a metal powder, a metal oxide powder and mixtures thereof, and an inorganic particulate filler having a hollow or a lamellar structure; and pyrolysing the resultant mixture.

18. A method according to claim 17, wherein, prior to pyrolysis, the mixture is coated on to a substrate.

19. In a structure having a thermal barrier coating, utilizing a composition as defined in claim 1, as the thermal barrier coating.

20. A composition according to claim 1, which comprises 20 to 70 weight % hollow or lamellar filler.
